(19) United States
(12) Patent Application Publication
(10) Pub. No.: US 2026/0040167 A1
(43) Pub. Date: Feb. 5, 2026

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 19/119,230

(22) PCT Filed: Oct. 19, 2022
(86) PCT No.: PCT/CN2022/126279

§ 371 Date: Apr. 8, 2025

(51) Int. Cl. H04W 36/04; H04W 8/30; H04W 28/06; H04W 76/20

(52) U.S. Cl. CPC H04W 36/04; H04W 8/30; H04W 28/06; H04W 76/20

(57) ABSTRACT

Embodiments of the present disclosure relate to methods, devices and computer readable media of communication. A terminal device receives information associated with a lower-layer signaling based cell switch and determines, based on the information, whether a set of procedures are performed during the lower-layer signaling based cell switch. The set of procedures comprises at least one of the following: a PDCP recovery for a set of DRBs; a PDCP SDU discard for a set of SRBs; a RRC re-establishment for a set of DRBs and a set of SRBs; or a MAC reset. In this way, a terminal device may determine whether to perform or skip some L2 procedures for subsequent lower-layer based mobility procedures.

### TECHNICAL FIELD

Embodiments of the present disclosure generally relate to the field of telecommunication, and in particular, to methods, devices and computer storage media of communication based on a lower-layer signaling.

### BACKGROUND

When user equipment (UE) moves from a coverage area of one cell to that of another cell, a change or addition or release of a serving cell may need to be performed. Currently, it has been proposed to trigger the change or addition or release of the serving cell by a lower-layer signaling such as layer 1 (L1) or layer 2 (L2) signaling. In one solution, a data transmission is performed with a change of a serving cell upon reception of the lower-layer signaling, which is also referred to as a lower-layer based mobility procedure. In this way, the latency, overhead and interruption time may be reduced. However, solutions for the lower-layer based mobility procedure are still incomplete and need to be further developed.

### SUMMARY

In general, embodiments of the present disclosure provide methods, devices and computer storage media of communication based on a lower-layer signaling.

In a first aspect, there is provided a method of communication. The method comprises: receiving, at a terminal device and from a network device, information associated with a lower-layer signaling based cell switch: and determining, based on the information, whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In a second aspect, there is provided a method of communication. The method comprises: receiving, at a terminal device and from a network device, a lower-layer signaling indicating a cell switch to a target cell; and transmitting, to the network device, an indication indicating completion of the cell switch, the indication comprising information of the target cell.

In a third aspect, there is provided a method of communication. The method comprises: transmitting, at a network device and to a terminal device, information associated with a lower-layer signaling based cell switch for determination of whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In a fourth aspect, there is provided a method of communication. The method comprises: transmitting, at a network device and to a terminal device, a lower-layer signaling indicating a cell switch to a target cell; and receiving, from the terminal device, an indication indicating completion of the cell switch, the indication comprising information of the target cell.

In a fifth aspect, there is provided a device of communication. The device comprises a processor configured to cause the device to perform the method according to any of the first or fourth aspects of the present disclosure.

In a sixth aspect, there is provided a computer readable medium having instructions stored thereon. The instructions, when executed on at least one processor, cause the at least one processor to perform the method according to any of the first to fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture in which some embodiments of the present disclosure can be implemented;

FIG. 1E illustrates a schematic diagram illustrating a process of lower-layer based mobility in which some embodiments of the present disclosure can be implemented;

FIG. 2 illustrates a schematic diagram illustrating a process of communication according to embodiments of the present disclosure;

FIG. 3A illustrates a schematic diagram illustrating an example process of communication based on a lower-layer signaling indicating a cell switch according to embodiments of the present disclosure;

FIG. 3B illustrates a schematic diagram illustrating an example process of communication based on a configuration for a lower-layer signaling based cell switch according to embodiments of the present disclosure;

FIG. 4 illustrates a schematic diagram illustrating another process of communication according to embodiments of the present disclosure;

FIG. 5A illustrates a schematic diagram illustrating an example process of communication based on a lower-layer signaling according to embodiments of the present disclosure;

FIG. 5B illustrates a schematic diagram illustrating an example process of communication based on a radio resource control (RRC) signaling according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure;

FIG. 8 illustrates an example method of communication implemented at a network device in accordance with some embodiments of the present disclosure;

FIG. 9 illustrates another example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell switch” may be interchangeably used with “reconfiguration with sync for secondary cell group (SCG) or master cell group (MCG)” or “a cell change”. The term “PSCell” refers to a SpCell of a SCG, the term “PCell” refers to a SpCell of a MCG, and the term “SpCell” refers to a primary cell of a SCG or MCG. The term “SCell” refers to a secondary cell. The term “L1/L2 based mobility” may be interchangeably used with “L1/L2-triggered mobility” or “L1-triggered mobility” or “L2-triggered mobility” (abbreviated as LTM). The term “lower-layer signaling” may be interchangeably used with “L1/L2 signaling”. The term “RRC reconfiguration” may be interchangeably used with “RRC reconfiguration message”. The term “data transmission” refers to the transmitting and receiving of data.

As mentioned above, when UE moves from a coverage area of one cell to that of another cell, a change or addition or release of a serving cell may need to be performed. Conventionally, the change or addition or release of the serving cell is triggered by layer 3 (L3) measurements and is done by RRC signaling triggered Reconfiguration with Synchronization for change of primary cell (PCell) and primary secondary cell (PSCell). All cases involve complete L2 and L1 resets, leading to longer latency, larger overhead and longer interruption time than beam switch mobility.

It has been proposed to trigger the cell switch based on a lower-layer signaling such as L1 or L2 signaling. In this way; the latency, overhead and interruption time may be reduced. However, there are still some issues during a lower-layer signaling based cell switch.

In conventional handover or PSCell change, whether to perform L2 procedures such as packet data convergence protocol (PDCP) recovery, PDCP service data unit (SDU) discard and radio link control (RLC) re-establishment is based on RRCReconfiguration received, and a medium access control (MAC) reset is always performed. For a lower-layer based mobility procedure, some of the L2 procedures may be omitted for an intra-distributed unit (intra-DU) mobility scenario. However, a trace of UE is unpredictable, and thus it is impossible to configure whether to perform some of the L2 procedures. Further, it is also unclear which one or ones of the L2 procedures can be omitted.

In view of this, embodiments of the present disclosure provide a solution of communication so as to overcome the above issue and other potential issues. In the solution, a network device transmits information associated with a lower-layer signaling based cell switch, and based on the information, a terminal device determines whether a set of procedures are performed. The set of procedures comprises at least one of the following: a PDCP recovery for a set of data radio bearers (DRBs); a PDCP SDU discard for a set of signaling radio bearers (SRBs); a RLC re-establishment for a set of DRBs and a set of SRBs; or a MAC reset.

In this way, a terminal device may determine whether to perform or skip some L2 procedures for subsequent lower-layer based mobility procedures (i.e., subsequent LTM).

In addition, for conventional mobility procedure, upon performance of handover or PSCell change, UE generates an RRCReconfigurationComplete message as a complete indication to a network. However, it is still unclear whether a configuration for each candidate cell comprises a RRCReconfiguration message. If there is no RRCReconfiguration message for each candidate cell, an issue is what is used as a response to a network as a complete indication.

In view of this, embodiments of the present disclosure provide another solution of communication so as to overcome this issue and other potential issues. In the solution, a terminal device receives, from a network device, a lower-layer signaling indicating a cell switch to a target cell, and transmits, to the network device, an indication indicating completion of the cell switch. The indication comprises information of the target cell. In this way, a network is able to be aware of completion or confirmation of a lower-layer based mobility.

Principles and implementations of the present disclosure will be described in detail below with reference to the figures.

### Example of Communication Network

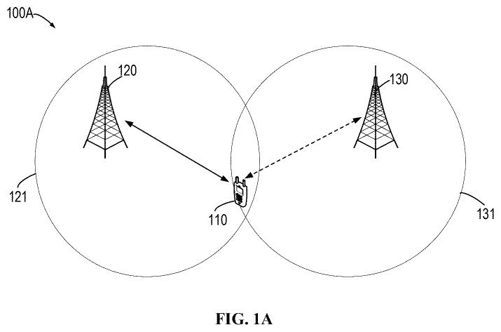

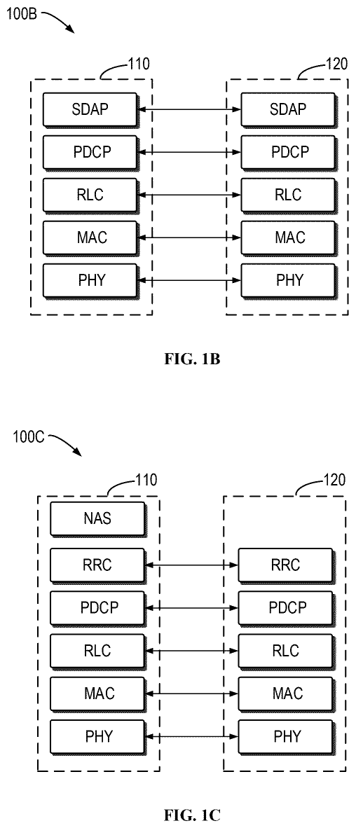

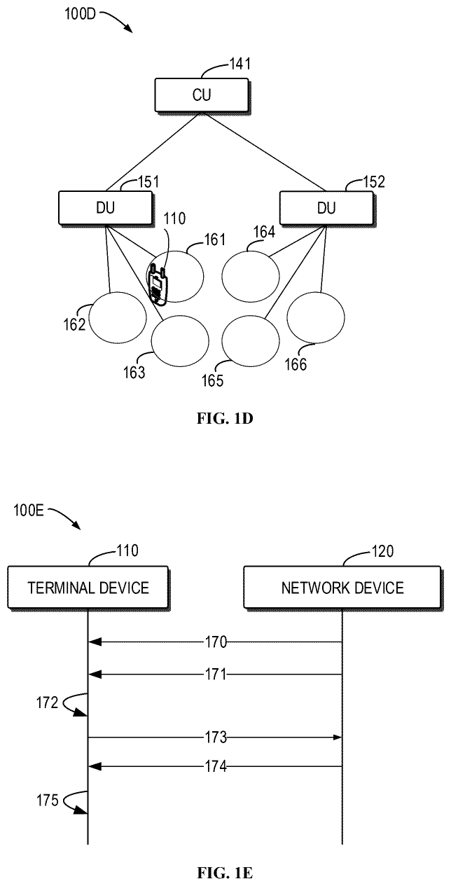

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New: Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. 5.5G, 5G-Advanced networks, or the sixth generation (6G) networks.

Communication in a direction from the terminal device 110 towards the network device 120 or 130 is referred to as uplink (UL) communication, while communication in a reverse direction from the network device 120 or 130 towards the terminal device 110 is referred to as downlink (DL) communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a MAC layer (also referred to as a MAC entity), an entity for a RLC layer (also referred to as a RLC entity), an entity for a PDCP layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture in which some embodiments of the present disclosure can be implemented. The CU/DU architecture may be established at a network device.

In the context of the present disclosure, a CU (also referred to as a gNB-CU herein) is a logic node hosting RRC, SDAP and PDCP protocols of a gNB or RRC and PDCP protocols of an en-gNB that controls operation of one or more DUs (also referred to as gNB-DUs herein). The gNB-CU terminates a F1 interface connected with the gNB-DU. A DU is a logical node hosting RLC, MAC and PHY layers of the gNB or en-gNB, and its operation is partly controlled by gNB-CU. One gNB-DU supports one or multiple cells. One cell is supported by only one gNB-DU. The gNB-DU terminates a F1 interface connected with the gNB-CU.

As shown in FIG. 1D, CU 141 is shown. It is to be understood that more CUs may be comprised. The CU 141 may communicate with multiple DUs. Here, two DUs 151 and 152 are shown for illustration. It is to be understood that more DUs may also be provided for implementation of embodiments of the present disclosure. Although not shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may provide cells 161, 162 and 163. DU 152 may provide cells 164, 165 and 166. It is to be understood that this is merely an example, and more or less cells are also feasible. The terminal device 110 may communicate with any of these cells.

In some embodiments, the terminal device 110 may switch from one cell to another cell under control of the same CU and same DU. For example, the terminal device 110 may be handed over from one cell 161 to another cell 162. This is called as an intra-CU intra-DU serving cell switch. In some embodiments, the terminal device 110 may switch from one cell to another cell under control of the same CU and different DUs. For example, the terminal device 110 may be handed over from one cell 161 to another cell 164. In this case, a cell switch from one cell of DU 151 to another cell of DU 152 will occur. This is called as an intra-CU inter-DU serving cell switch. In another example, the terminal device 110 may be handed over from a cell of one DU to a cell of another DU under control of different CUs. In this case, a handover from a CU to another CU will occur. This is called as an inter-CU handover.

The network device 120 and the network device 130 may correspond to one or two devices under the same CU. In some embodiments, a CU and a DU may be implemented in separate devices. In some embodiments, a CU and a DU may be implemented in the same device. In some embodiments, different DUs may be implemented in separate devices.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 131. This is called as a handover. In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 131. This is called as a PScell change.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with an addition, modification or change of the serving cell. This procedure is called as the lower-layer based mobility.

FIG. 1E illustrates a schematic diagram illustrating a process 100E of lower-layer based mobility in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 1E, the network device 120 may transmit 170, to the terminal device 110, a RRC reconfiguration comprising a set of RRC configurations corresponding to a set of candidate cells allowing L1/L2 based mobility. The network device 120 may also transmit 171, to the terminal device 110, a configuration of beams (for example, a synchronization signal and physical broadcast channel block (SSB) or a channel state information-reference signal (CSI-RS)) of a candidate cell for L1 measurement.

The terminal device 110 may perform 172 the L1 measurement based on the configuration. If a certain condition is fulfilled by a beam, e.g., quality of the beam is above threshold quality, the terminal device 110 may report 173 an indication of the beam (e.g., an identity (ID) associated with the beam) to the network device 120.

The network device 120 may transmit 174, to the terminal device 110, a L1/L2 signaling (e.g., downlink control information (DCI) or a medium access control (MAC) control element (CE)). The L1/L2 signaling indicates that transmission configuration indicator (TCI) state(s) for a cell among candidate cells are activated along with a cell switch.

Upon reception of the L1/L2 signaling, the terminal device 110 may perform 175 the cell switch. For example, the lower layer (e.g., PHY or MAC layer) of the terminal device 110 indicates, to the RRC layer of the terminal device 110, information of the cell switch, e.g. an ID associated with the target cell. The L1/L2 signaling may also indicate that a TCI state for a cell with different physical cell identifier (PCI) is activated along with the cell switch. Upon reception of the indication, the RRC layer performs the cell switch by applying the configuration corresponding to the target cell. The target cell may be PCell, PSCell or SCell of the terminal device 110. And the terminal device 110 may start a data transmission with the target cell using a pre-configured UE-dedicated channel and the activated TCI states.

For a lower-layer based mobility, some of L2 procedures may be omitted for an intra-DU mobility scenario so as to save mobility latency. However, a trace of UE is unpredictable, and thus it is impossible to configure whether to perform some of L2 procedures. Further, it is also unclear which one or ones of the L2 procedures can be omitted.

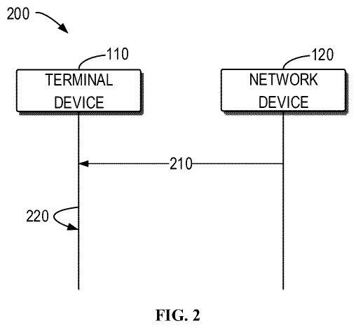

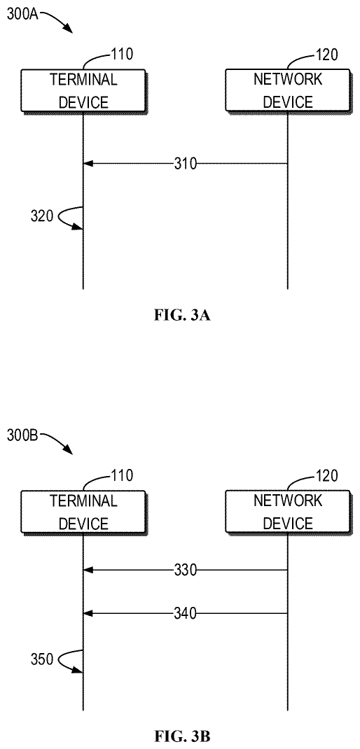

Embodiments of the present disclosure provide a solution of indicating whether to perform some of L2 procedures. Its detail will be described with reference to FIGS. 2 to 3B.

### Example Implementation of Decision of Whether to Perform L2 Procedures

FIG. 2 illustrates a schematic diagram illustrating a process 200 of communication according to embodiments of the present disclosure. For the purpose of discussion, the process 200 will be described with reference to FIG. 1A. The process 200 may involve the terminal device 110 and the network device 120 as illustrated in FIG. 1A. In this example, the network device 120 serves the terminal device 110.

As shown in FIG. 2, the network device 120 may transmit 210, to the terminal device 110, information associated with a lower-layer signaling based cell switch (i.e., a lower-layer based mobility). In some embodiments, the information may comprise information (for convenience, also referred to as first information herein) regarding whether to perform a set of procedures for a lower-layer signaling based cell switch. In some embodiments, the information may comprise information (for convenience, also referred to as second information herein) assistant for the terminal device 110 to decide whether to perform a set of procedures for a lower-layer signaling based cell switch.

Continue to refer to FIG. 2, based on the first information or second information, the terminal device 110 determines 220 whether the set of procedures are performed for the lower-layer signaling based cell switch. In some embodiments, the set of procedures may comprise a PDCP SDU discard for a set of SRBs. For example, for the set of SRBs, a PDCP entity of the terminal device 110 may discard all stored PDCP SDUs and PDCP protocol data units (PDUs).

In some alternative or additional embodiments, the set of procedures may comprise a PDCP recovery for a set of DRBs. In some alternative or additional embodiments, the set of procedures may comprise a RLC re-establishment for a set of DRBs and a set of SRBs. In some alternative or additional embodiments, the set of procedures may comprise a MAC reset. It is to be understood that the set of procedures may comprise any combination of the above procedures and any other suitable procedures. In some embodiments, the set of procedures may also be referred to as L2 reset procedures.

In some embodiments where the set of procedures are not performed, the terminal device 110 may perform a LTM specific MAC reset (also referred to as partial MAC reset here). In some embodiments for the LTM specific MAC reset, the terminal device 110 may continue data transmission/reception processing related procedure in MAC layer and may perform at least one of the following operations:
do not reset Bj for each logical channel to zero/maintain Bj for each logical channel;
do not cancel/maintain triggered Scheduling Request procedure;
do not cancel/maintain triggered Buffer Status Reporting procedure;
do not clear/Maintain buffers for all hybrid automatic repeat request (HARQ) processes;
do not set the new data indicator (NDI) to 0 for all uplink HARQ processes/maintain the NDIs for all HARQ processes; or
do not consider the timeAlignmentTimer for all timing advance groups (TAGs) as expiry/maintain the timeAlignmentTimer for all TAGs.

In some alternative embodiments for the LTM specific MAC reset, the terminal device 110 may perform at least one of the following operations:
stop (if running) all timers;
stop, if any, ongoing Random Access (RA) procedure;
discard explicitly signalled contention-free RA resources for 4-step RA type and 2-step RA type, if any;
flush Msg3 buffer;
flush MSGA buffer;
cancel, if any, triggered Power Headroom Reporting procedure;
cancel, if any, triggered consistent listen before talk (LBT) failure;
cancel, if any, triggered beam failure report (BFR);
cancel, if any, triggered Recommended bit rate query procedure;
cancel, if any, triggered configured uplink grant confirmation;
cancel, if any, triggered Desired Guard Symbol query;
release, if any, temporary cell-radio network temporary identifier (C-RNTI);
reset all beam failure instance (BFI)_COUNTERs; or
reset all LBT_COUNTERS.

For illustration, some example embodiments will be described in connection with Embodiments 1 and 2.

### Embodiment 1

In this embodiment, the network device 120 may transmit the first information in a lower-layer signaling indicating a cell switch. In some embodiments, the lower-layer signaling may be a MAC CE. In some embodiments, the lower-layer signaling may be DCI. For illustration, detailed description will be given in connection with FIG. 3A.

FIG. 3A illustrates a schematic diagram illustrating an example process 300A of communication based on a lower-layer signaling indicating a cell switch according to embodiments of the present disclosure. For the purpose of discussion, the process 300A will be described with reference to FIG. 1A. The process 300A may involve the terminal device 110 and the network device 120 as illustrated in FIG. 1A. In this example, the network device 120 serves the terminal device 110.

As shown in FIG. 3A, the network device 120 may transmit 310, to the terminal device 110, a lower-layer signaling indicating a cell switch. In some embodiments, a CU (e.g., CU 141) of the network device 120 may transmit, to a source DU (e.g., DU 151) of the network device 120, an indication indicating whether the set of procedures is to be performed. Based on the indication, the source DU may generate the lower-layer signaling indicating the cell switch. The source DU may transmit the generated lower-layer signaling to the terminal device 110.

The lower-layer signaling comprises the first information regarding whether to perform the set of procedures for the lower-layer signaling based cell switch. In some embodiments, the lower-layer signaling may be a MAC CE. In some embodiments, the lower-layer signaling may be DCI.

In some embodiments, the first information may comprise an indication indicating whether the set of procedures are performed. In some embodiments, the indication may comprise a single indication regarding whether all procedures in the set of procedures are performed or not performed. In some embodiments, the indication may comprise a set of indications. An indication in the set of indications indicates whether a procedure in the set of procedures is performed.

In some alternative or additional embodiments, the first information may comprise an indication indicating a mobility scenario of the cell switch.

With reference to FIG. 3A, the terminal device 110 may determine 320, based on the first information, whether to perform the set of procedures for the cell switch.

In some embodiments where the first information comprises an indication indicating whether the set of procedures are performed, if the indication indicates that the set of procedures are not to be performed, the terminal device 110 may determine that the set of procedures are not performed. If the indication indicates that the set of procedures are to be performed, the terminal device 110 may determine that the set of procedures are performed.

In some embodiments where the first information comprises the indication indicating the mobility scenario of the cell switch, if the mobility scenario of the cell switch is an intra-CU intra-DU scenario, the terminal device 110 may determine that the set of procedures are not performed. If the mobility scenario of the cell switch is an intra-CU inter-DU scenario, the terminal device 110 may determine that the set of procedures are performed.

In some embodiments, upon reception of the first information, a lower layer (e.g., MAC layer) of the terminal device 110 may transmit, to upper layers (e.g., RRC, PDCP and RLC layers) of the terminal device 110, an indication indicating that the set of procedures are performed. The upper layers may perform the set of procedures. In some embodiments, upon reception of the first information, the lower layer may transmit, to the upper layers, an indication indicating whether the set of procedures are performed. The upper layers may perform or skip the set of procedures based on the indication from the lower layer.

In some embodiments, upon reception of the first information, the lower layer of the terminal device 110 may transmit the indication to the RRC layer and the RRC layer may instruct lower layers (PDCP, RLC and MAC layers) to perform or skip the set of procedures. In some embodiments, the lower layer of the terminal device 110 may transmit the indication to the PDCP and RLC layers directly, and the PDCP and RLC layers perform or skip the set of procedures accordingly based on the indication from the lower layers (e.g. MAC layer).

In this way, a terminal device may decide whether to perform or skip some L2 procedures for subsequent lower-layer based mobility.

### Embodiment 2

In this embodiment, the network device 120 may transmit the second information in a configuration for a lower-layer signaling based cell switch. In some embodiments, the network device 120 may transmit, in a RRC message, the configuration for the lower-layer signaling based cell switch and the configuration comprises assistance information (i.e., the second information) for the terminal device 110 to decide whether to perform the set of procedures. For illustration, detailed description will be given in connection with FIG. 3B.

FIG. 3B illustrates a schematic diagram illustrating an example process 300B of communication based on a configuration for a lower-layer signaling based cell switch according to embodiments of the present disclosure. For the purpose of discussion, the process 300B will be described with reference to FIG. 1A. The process 300B may involve the terminal device 110 and the network device 120 as illustrated in FIG. 1A. In this example, the network device 120 serves the terminal device 110.

As shown in FIG. 3B, the network device 120 may transmit 330, to the terminal device 110, a configuration for a lower-layer signaling based cell switch. The configuration comprises the second information.

In some embodiments, the second information may comprise information (e.g., identity) of a DU or cell group associated with a candidate cell in a set of candidate cells.

In some embodiments, the second information may comprise an indication of whether the set of procedures are performed during a cell switch from one candidate cell to another second candidate cell in a set of candidate cells. For example, the second information may comprise a plurality of lists, and each list in the plurality of lists indicates, for a candidate cell, whether the set of procedures are performed during a cell switch from the candidate cell to each of other candidate cells.

In some embodiments, the second information may comprise an indication of a cell switch from one candidate cell to another candidate cell in a set of candidate cells that does not require performance of the set of procedures. For example, the second information may comprise a plurality of lists, and each list in the plurality of lists indicates, for a candidate cell, one or more cell switches from the candidate cell to other candidate cells which do not require performance of the set of procedures.

In some embodiments, the second information may comprise an indication of a cell switch from one candidate cell to another candidate cell in a set of candidate cells that requires performance of the set of procedures. For example, the second information may comprise a plurality of lists, and each list in the plurality of lists indicates, for a candidate cell, one or more cell switches from the candidate cell to other candidate cells which require performance of the set of procedures.

Continue to refer to FIG. 3B, the network device 120 may further transmit 340, to the terminal device 110, a lower-layer signaling indicating a cell switch. In this case, the terminal device 110 may determine 350, based on the second information, whether to perform the set of procedures for the cell switch.

In some embodiments where the second information comprises information of a DU or cell group associated with a candidate cell in a set of candidate cells, if a target cell and a source cell associated with the cell switch are associated with different DUs or cell groups, the terminal device 110 may determine that the set of procedures are performed. If the target cell and the source cell are associated with a same DU or cell group, the terminal device 110 may determine that the set of procedures are not performed.

In some embodiments where the second information comprises an indication of whether the set of procedures are performed during a cell switch from one candidate cell to another second candidate cell in a set of candidate cells, the terminal device 110 may determine, based on the indication, whether the set of procedures are performed during the cell switch from a source cell to a target cell. If the set of procedures are indicated to be performed during the cell switch, the terminal device 110 may determine that the set of procedures are performed. If the set of procedures are not indicated to be performed during the cell switch, the terminal device 110 may determine that that the set of procedures are not performed.

In some embodiments where the second information comprises an indication of a cell switch from one candidate cell to another candidate cell in a set of candidate cells that does not require performance of the set of procedures, if the second information comprises an indication of the cell switch from a source cell to a target cell, the terminal device 110 may determine that the set of procedures are not performed. If the second information does not comprise an indication of the cell switch from a source cell to a target cell, the terminal device 110 may determine that the set of procedures are performed.

In some embodiments where the second information comprises an indication of a cell switch from one candidate cell to another candidate cell in a set of candidate cells that requires performance of the set of procedures, if the second information comprises an indication of the cell switch from a source cell to a target cell, the terminal device 110 may determine that the set of procedures are performed. If the second information does not comprise an indication of the cell switch from a source cell to a target cell, the terminal device 110 may determine that the set of procedures are not performed.

In some embodiments, if the configuration does not comprise the second information, the terminal device 110 may determine that the set of procedures are performed.

In some embodiments, the terminal device 110 may determine whether the set of procedures are performed for the subsequent cell switch based on the second information. In some embodiments, the terminal device 110 may determine whether the set of procedures are performed for the first cell switch after reception of RRC Reconfiguration for LTM based on the second information. In some embodiments, the terminal device 110 may determine the set of procedures are performed for the first cell switch after reception of RRC Reconfiguration for LTM based on a recoverPDCP information element (IE), a discardOnPDCP IE and a reestablishRLC IE included in the configuration associated with the target candidate cell.

In this way; a terminal device may also decide whether to perform or skip some L2 procedures for subsequent lower-layer based mobility.

### Example Implementation of Indication of Completion of Lower-Layer Based Mobility

As mentioned above, it is still unclear whether a configuration for each candidate cell comprises a RRCReconfiguration message. If there is no RRCReconfiguration message for each candidate cell, an issue is what is used as a response to a network as a complete indication.

In view of this, embodiments of the present disclosure provide a solution of indicating completion of a lower-layer based mobility by a terminal device. This will be described below in connection with FIG. 4.

FIG. 4 illustrates a schematic diagram illustrating another process 400 of communication according to embodiments of the present disclosure. For the purpose of discussion, the process 400 will be described with reference to FIG. 1A. The process 400 may involve the terminal device 110 and the network device 120 as illustrated in FIG. 1A. In this example, the network device 120 serves the terminal device 110.

As shown in FIG. 4, the network device 120 transmits 410, to the terminal device 110, a lower-layer signaling indicating a cell switch to a target cell. In some embodiments, the lower-layer signaling may be a MAC CE. In some embodiments, the lower-layer signaling may be a MAC CE with a fixed size of zero bits. In some embodiments, the lower-layer signaling may be DCI.

Continue to refer to FIG. 4, the terminal device 110 transmits 420, to the network device 120, an indication indicating completion of the cell switch, the indication comprising information of the target cell.

In some embodiments, the terminal device 110 may transmit a further lower-layer signaling comprising the indication. In some embodiments, the further lower-layer signaling may be a MAC CE. In some embodiments, the further lower-layer signaling may be a MAC CE with a fixed size of zero bits. In some embodiments, the further lower-layer signaling may be DCI.

In some embodiments, the terminal device 110 may transmit a RRC signaling comprising the indication. In some embodiments, the RRC signaling may be RRC Reconfiguration Complete message.

In some embodiments, the information of the target cell may comprise an identity of the target cell. In some embodiments, the information of the target cell may comprise an identity of a configuration of a lower-layer signaling based cell switch associated with the target cell. It is to be understood that any combination of the above information and any other suitable information may also be feasible.

For illustration, some example embodiments will be described in connection with Embodiments 3 and 4.

### Embodiment 3

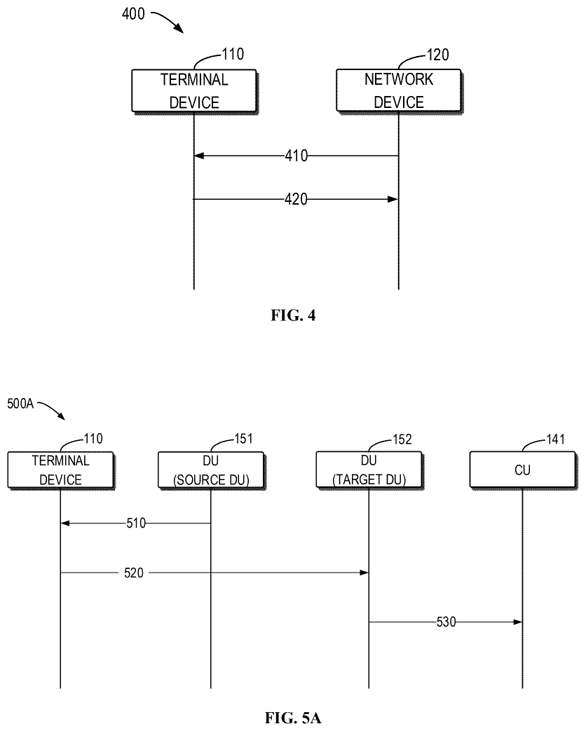

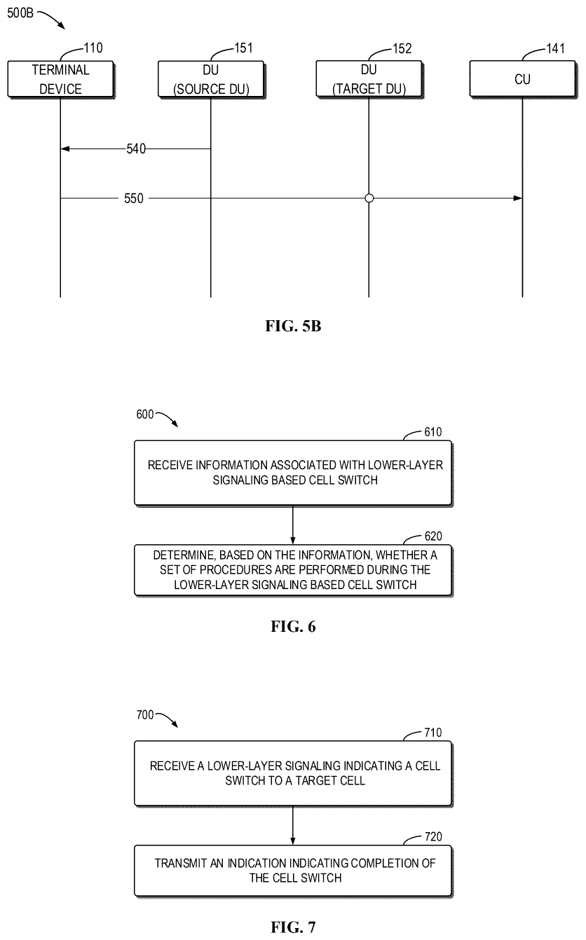

In this embodiment, the terminal device 110 may transmit a lower-layer signaling comprising the indication indicating completion of the cell switch. For illustration, detailed description will be given in connection with FIG. 5A.

FIG. 5A illustrates a schematic diagram illustrating an example process 500A of communication based on a lower-layer signaling according to embodiments of the present disclosure. For the purpose of discussion, the process 500A will be described with reference to FIG. 1D. The process 500A may involve the terminal device 110, the CU 141 and the DUs 151 and 152 as illustrated in FIG. 1D. In this example, the DU 151 serves the terminal device 110 and serves as a source DU, and the DU 152 does not serve the terminal device 110 and serves as a target DU.

As shown in FIG. 5A, the DU 151 transmits 510, to the terminal device 110, a lower-layer signaling indicating a cell switch to a target cell (e.g., the cell 164 of the DU 152). In some embodiments, the lower-layer signaling may be a MAC CE. In some embodiments, the lower-layer signaling may be a MAC CE with a fixed size of zero bits. In some embodiments, the lower-layer signaling may be DCI.

Continue to refer to FIG. 5A, the terminal device 110 transmits 520, to the DU 152, a further lower-layer signaling indicating completion of the cell switch. The further lower-layer signaling comprises information of the target cell. In some embodiments, the further lower-layer signaling may be a MAC CE. In some embodiments, the further lower-layer signaling may be a MAC CE with a fixed size of zero bits. In some embodiments, the further lower-layer signaling may be DCI.

The DU 152 transmits 530, to the CU 141, information indicating completion of the cell switch. The information comprises the information of the target cell. In some embodiments, the information of the target cell may comprise an identity of the target cell. In some embodiments, the information of the target cell may comprise an identity of a configuration of a lower-layer signaling based cell switch associated with the target cell. It is to be understood that any combination of the above information and any other suitable information may also be feasible.

In this way, a network is able to be aware of completion or confirmation of a lower-layer based mobility.

### Embodiment 4

In this embodiment, the terminal device 110 may transmit a RRC signaling comprising the indication indicating completion of the cell switch. For illustration, detailed description will be given in connection with FIG. 5B.

FIG. 5B illustrates a schematic diagram illustrating an example process 500B of communication based on a RRC signaling according to embodiments of the present disclosure. For the purpose of discussion, the process 500B will be described with reference to FIG. 1D. The process 500B may involve the terminal device 110, the CU 141 and the DUs 151 and 152 as illustrated in FIG. 1D. In this example, the DU 151 serves the terminal device 110 and serves as a source DU, and the DU 152 does not serve the terminal device 110 and serves as a target DU.

As shown in FIG. 5B, the DU 151 transmits 540, to the terminal device 110, a lower-layer signaling indicating a cell switch to a target cell (e.g., the cell 164 of the DU 152). In some embodiments, the lower-layer signaling may be a MAC CE. In some embodiments, the lower-layer signaling may be a MAC CE with a fixed size of zero bits. In some embodiments, the lower-layer signaling may be DCI.

Continue to refer to FIG. 5B, the terminal device 110 transmits 550, to the CU 141 via the DU 152, a RRC signaling indicating completion of the cell switch. That is, the terminal device 110 may transmit the RRC signaling to the DU 152, and the DU 152 may forward the RRC signaling to the CU 141.

The RRC signaling may comprise information of the target cell. In some embodiments, the information of the target cell may comprise an identity of the target cell. In some embodiments, the information of the target cell may comprise an identity of a configuration of a lower-layer signaling based cell switch associated with the target cell. It is to be understood that any combination of the above information and any other suitable information may also be feasible.

In this way, a network is also able to be aware of completion or confirmation of a lower-layer based mobility.

### Example Implementation of Methods

Accordingly, embodiments of the present disclosure provide methods of communication implemented at a terminal device and a network device. These methods will be described below with reference to FIGS. 6 to 9.

FIG. 6 illustrates an example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 110 receives, from the network device 120, information associated with a lower-layer signaling based cell switch.

In some embodiments, the terminal device 110 may receive a lower-layer signaling indicating a cell switch, the lower-layer signaling comprising first information regarding whether to perform the set of procedures for the lower-layer signaling based cell switch. In some embodiments, the first information may comprise an indication indicating whether the set of procedures are performed. In some embodiments, the first information may comprise an indication indicating a mobility scenario of the cell switch.

In some embodiments, the terminal device 110 may receive a configuration for the lower-layer signaling based cell switch, the configuration comprising second information assistant for the terminal device to decide whether to perform the set of procedures for the lower-layer signaling based cell switch. In some embodiments, the second information may comprise an indication of a DU associated with a candidate cell in a set of candidate cells. In some embodiments, the second information may comprise an indication of whether the set of procedures are performed during a cell switch from one candidate cell to another second candidate cell in a set of candidate cells. In some embodiments, the second information may comprise an indication of a cell switch from one candidate cell to another candidate cell in a set of candidate cells that does not require performance of the set of procedures. In some embodiments, the second information may comprise an indication of a cell switch from one candidate cell to another candidate cell in a set of candidate cells that requires performance of the set of procedures.

At block 620, the terminal device 110 determines, based on the information, whether a set of procedures are performed during the lower-layer signaling based cell switch. The set of procedures comprises at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments where the first information comprises an indication indicating whether the set of procedures are performed, if the indication indicates that the set of procedures are not to be performed, the terminal device 110 may determine that the set of procedures are not performed. If the indication indicates that the set of procedures are to be performed, the terminal device 110 may determine that the set of procedures are performed.

In some embodiments where the first information comprises an indication indicating a mobility scenario of the cell switch, if the mobility scenario of the cell switch is an intra-CU and intra-DU scenario, the terminal device 110 may determine that the set of procedures are not performed. If the mobility scenario of the cell switch is an intra-CU and inter-DU scenario, the terminal device 110 may determine that the set of procedures are performed.

In some embodiments, the terminal device 110 may transmit, from a lower layer of the terminal device 110 to upper layers of the terminal device 110, an indication indicating that the set of procedures are performed. The upper layers may perform the set of procedures.

In some embodiments where the second information comprises information of a distributed unit associated with a candidate cell in a set of candidate cells, if a target cell and a source cell are associated with different DUs, the terminal device 110 may determine that the set of procedures are performed. If a target cell and a source cell are associated with a same DU, the terminal device 110 may determine that the set of procedures are not performed.

In some embodiments where the second information comprises an indication of whether the set of procedures are performed during a cell switch from one candidate cell to another second candidate cell in a set of candidate cells, if the set of procedures are performed during a cell switch from a source cell to a target cell, the terminal device 110 may determine that the set of procedures are performed. If the set of procedures are not performed during a cell switch from a source cell to a target cell, the terminal device 110 may determine that the set of procedures are not performed.

In some embodiments where the second information comprises an indication of a cell switch from one candidate cell to another candidate cell in a set of candidate cells that does not require performance of the set of procedures, if the second information comprises an indication of a cell switch from a source cell to a target cell, the terminal device 110 may determine that the set of procedures are not performed. If the second information does not comprise an indication of a cell switch from a source cell to a target cell, the terminal device 110 may determine that the set of procedures are performed.

In some embodiments where the second information comprises an indication of a cell switch from one candidate cell to another candidate cell in a set of candidate cells that requires performance of the set of procedures, if the second information comprises an indication of a cell switch from a source cell to a target cell, the terminal device 110 may determine that the set of procedures are performed. If the second information does not comprise an indication of a cell switch from a source cell to a target cell, the terminal device 110 may determine that the set of procedures are not performed.

In some embodiments where a configuration for the lower-layer signaling based cell switch is received, if the configuration does not comprise the second information, the terminal device may determine that the set of procedures are performed.

With the method 600, a terminal device may determine whether to perform or skip some L2 procedures for subsequent lower-layer based mobility procedures.

FIG. 7 illustrates an example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 receives, from the network device 120, a lower-layer signaling indicating a cell switch to a target cell.

At block 720, the terminal device 110 transmits, to the network device 120, an indication indicating completion of the cell switch, the indication comprising information of the target cell.

In some embodiments, the terminal device 110 may transmit a further lower-layer signaling comprising the indication. In some embodiments, the terminal device 110 may transmit the further lower-layer signaling to a DU of the network device 120 associated with the target cell for transmission of the information of the target cell to a CU of the network device 120.

In some embodiments, the terminal device 110 may transmit a RRC signaling comprising the indication. In some embodiments, the terminal device 110 may transmit the RRC signaling to a CU of the network device 120 via a DU of the network device 120 associated with the target cell.

In some embodiments, the information of the target cell may comprise at least one of the following: an identity of the target cell; or an identity of a configuration of a lower-layer signaling based cell switch associated with the target cell.

With the method 700, a network is able to be aware of completion or confirmation of a lower-layer based mobility.

FIG. 8 illustrates an example method 800 of communication implemented at a network device in accordance with some embodiments of the present disclosure. For example, the method 800 may be performed at the network device 120 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the network device 120 transmits, to the terminal device 110, information associated with a lower-layer signaling based cell switch for determination of whether a set of procedures are performed during the lower-layer signaling based cell switch. The set of procedures comprises at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments, the network device 120 may transmit a lower-layer signaling indicating a cell switch, the lower-layer signaling comprising first information regarding whether to perform the set of procedures for the lower-layer signaling based cell switch. In some embodiments, the first information may comprise at least one of the following: an indication indicating whether the set of procedures are performed; or an indication indicating a mobility scenario of the cell switch.

In some embodiments, the network device 120 may transmit a configuration for the lower-layer signaling based cell switch, the configuration comprising second information assistant for the terminal device to decide whether to perform the set of procedures for the lower-layer signaling based cell switch. In some embodiments, the second information may comprise at least one of the following: information of a distributed unit associated with a candidate cell in a set of candidate cells; an indication of whether the set of procedures are performed during a cell switch from one candidate cell to another second candidate cell in a set of candidate cells; an indication of a cell switch from one candidate cell to another candidate cell in a set of candidate cells that does not require performance of the set of procedures; or an indication of a cell switch from one candidate cell to another candidate cell in a set of candidate cells that requires performance of the set of procedures.

In some embodiments, the network device 120 may transmit a configuration for the lower-layer signaling based cell switch, the configuration comprising no information associated with a lower-layer signaling based cell switch.

With the method 800, a network device may indicate a terminal device to determine whether to perform or skip some L2 procedures for subsequent lower-layer based mobility procedures.

FIG. 9 illustrates an example method 900 of communication implemented at a network device in accordance with some embodiments of the present disclosure. For example, the method 900 may be performed at the network device 120 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard.

At block 910, the network device 120 transmits, to the terminal device 110, a lower-layer signaling indicating a cell switch to a target cell.

At block 920, the network device 120 receives, from the terminal device 110, an indication indicating completion of the cell switch, the indication comprising information of the target cell.

In some embodiments, the network device 120 may receive a further lower-layer signaling comprising the indication. In some embodiments, the network device 120 may receive the further lower-layer signaling at a DU of the network device 120 associated with the target cell, and transmit, at the DU and to a CU of the network device 120, information indicating completion of the cell switch, the information comprising the information of the target cell.

In some embodiments, the network device 120 may receive a RRC signaling comprising the indication. In some embodiments, the network device 120 may receive the RRC signaling at a DU of the network device 120, and forward, by the DU, the RRC signaling to a CU of the network device 120.

In some embodiments, the information of the target cell comprises at least one of the following: an identity of the target cell; or an identity of a configuration of a lower-layer signaling based cell switch associated with the target cell.

It is to be understood that the operations of methods 600 to 900 are similar as that described in connection with FIGS. 2 to 5B, and thus other details are not repeated here for concise.

### Example Implementation of Devices and Apparatuses

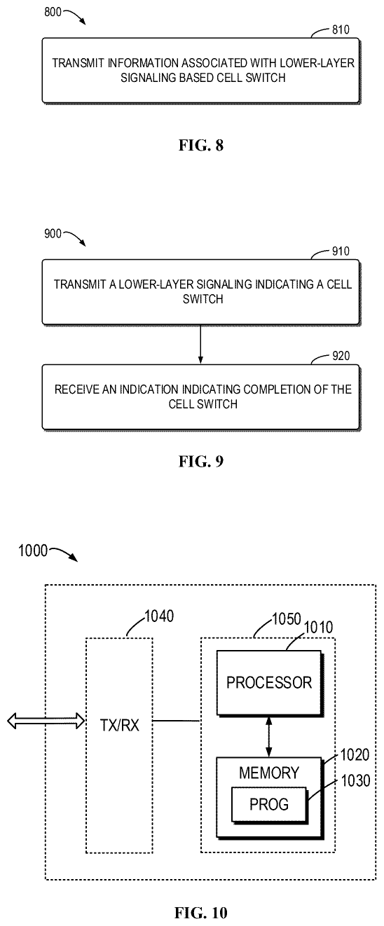

FIG. 10 is a simplified block diagram of a device 1000 that is suitable for implementing embodiments of the present disclosure. The device 1000 can be considered as a further example implementation of the terminal device 110 or the network device 120 as shown in FIG. 1A, or the CU 141, the DU 151 or the DU 152 as shown in FIG. 1D. Accordingly, the device 1000 can be implemented at or as at least a part of the terminal device 110 or the network device 120 or the CU 141 or the DU 151 or 152.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: receive, from a network device, information associated with a lower-layer signaling based cell switch; and determine, based on the information, whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments, a terminal device comprises a circuitry configured to: receive, from a network device, a lower-layer signaling indicating a cell switch to a target cell; and transmit, to the network device, an indication indicating completion of the cell switch, the indication comprising information of the target cell.

In some embodiments, a network device comprises a circuitry configured to: transmit, to a terminal device, information associated with a lower-layer signaling based cell switch for determination of whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments, a network device comprises a circuitry configured to: transmit, to a terminal device, a lower-layer signaling indicating a cell switch to a target cell; and receive, from the terminal device, an indication indicating completion of the cell switch, the indication comprising information of the target cell.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receive, at a terminal device and from a network device, information associated with a lower-layer signaling based cell switch; and determine, based on the information, whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments, receiving the information comprises: receiving, at the terminal device and from the network device, a lower-layer signaling indicating a cell switch, the lower-layer signaling comprising first information regarding whether to perform the set of procedures for the lower-layer signaling based cell switch.

In some embodiments, the first information comprises an indication indicating whether the set of procedures are performed. In these embodiments, determining whether the set of procedures are performed comprises: in accordance with a determination that the indication indicates that the set of procedures are not performed, determining that the set of procedures are not performed; or in accordance with a determination that the indication indicates that the set of procedures are performed, determining that the set of procedures are performed.

In some embodiments, the first information comprises an indication indicating a mobility scenario of the cell switch. In these embodiments, determining whether the set of procedures are performed comprises: in accordance with a determination that the mobility scenario of the cell switch is an intra-central unit and intra-distributed unit scenario, determining that the set of procedures are not performed; or in accordance with a determination that the mobility scenario of the cell switch is an intra-central unit and inter-distributed unit scenario, determining that the set of procedures are performed.

In some embodiments, the method further comprises: transmitting, from a lower layer of the terminal device to upper layers of the terminal device, an indication indicating that the set of procedures are performed; and performing the set of procedures by the upper layers.

In some embodiments, receiving the information comprises: receiving, at the terminal device and from the network device, a configuration for the lower-layer signaling based cell switch, the configuration comprising second information assistant for the terminal device to decide whether to perform the set of procedures for the lower-layer signaling based cell switch.

In some embodiments, the second information comprises information of a distributed unit associated with a candidate cell in a set of candidate cells. In these embodiments, determining whether the set of procedures are performed comprises: in accordance with a determination that a target cell and a source cell are associated with different distributed units, determining that the set of procedures are performed; or in accordance with a determination that a target cell and a source cell are associated with a same distributed unit, determining that the set of procedures are not performed.

In some embodiments, the second information comprises an indication of whether the set of procedures are performed during a cell switch from one candidate cell to another second candidate cell in a set of candidate cells. In these embodiments, determining whether the set of procedures are performed comprises: in accordance with a determination that the set of procedures are performed during a cell switch from a source cell to a target cell, determining that the set of procedures are performed; or in accordance with a determination that the set of procedures are not performed during a cell switch from a source cell to a target cell, determining that the set of procedures are not performed.

In some embodiments, the second information comprises an indication of a cell switch from one candidate cell to another candidate cell in a set of candidate cells that does not require performance of the set of procedures. In these embodiments, determining whether the set of procedures are performed comprises: in accordance with a determination that the second information comprises an indication of a cell switch from a source cell to a target cell, determining that the set of procedures are not performed; or in accordance with a determination that the second information does not comprise an indication of a cell switch from a source cell to a target cell, determining that the set of procedures are performed.

In some embodiments, the second information comprises an indication of a cell switch from one candidate cell to another candidate cell in a set of candidate cells that requires performance of the set of procedures. In these embodiments, determining whether the set of procedures are performed comprises: in accordance with a determination that the second information comprises an indication of a cell switch from a source cell to a target cell, determining that the set of procedures are performed; or in accordance with a determination that the second information does not comprise an indication of a cell switch from a source cell to a target cell, determining that the set of procedures are not performed.

In some embodiments, receiving the information further comprises: receiving, at the terminal device and from the network device, a configuration for the lower-layer signaling based cell switch. In some embodiments, determining whether the set of procedures are performed comprises: in accordance with a determination that the configuration does not comprise the second information, determining that the set of procedures are performed.

In another solution, a method of communication comprises: receiving, at a terminal device and from a network device, a lower-layer signaling indicating a cell switch to a target cell; and transmitting, to the network device, an indication indicating completion of the cell switch, the indication comprising information of the target cell.

In some embodiments, transmitting the indication comprises: transmitting a further lower-layer signaling comprising the indication; or transmitting a radio resource control signaling comprising the indication.

In some embodiments, transmitting the further lower-layer signaling comprises: transmitting the further lower-layer signaling to a distributed unit of the network device associated with the target cell for transmission of the information of the target cell to a central unit of the network device.

In some embodiments, transmitting the radio resource control signaling comprises: transmitting the radio resource control signaling to a central unit of the network device via a distributed unit of the network device associated with the target cell.

In some embodiments, the information of the target cell comprises at least one of the following: an identity of the target cell; or an identity of a configuration of a lower-layer signaling based cell switch associated with the target cell.

In another solution, a method of communication comprises: transmitting, at a network device and to a terminal device, information associated with a lower-layer signaling based cell switch for determination of whether a set of procedures are performed during the lower-layer signaling based cell switch, the set of procedures comprising at least one of the following: a packet data convergence protocol recovery for a set of data radio bearers; a packet data convergence protocol service data unit discard for a set of signaling radio bearers; a radio link control re-establishment for a set of data radio bearers and a set of signaling radio bearers; or a medium access control reset.

In some embodiments, transmitting the information comprises: transmitting a lower-layer signaling indicating a cell switch, the lower-layer signaling comprising first information regarding whether to perform the set of procedures for the lower-layer signaling based cell switch.

In some embodiments, the first information comprises at least one of the following: an indication indicating whether the set of procedures are performed; or an indication indicating a mobility scenario of the cell switch.

In some embodiments, transmitting the information comprises: transmitting a configuration for the lower-layer signaling based cell switch, the configuration comprising second information assistant for the terminal device to decide whether to perform the set of procedures for the lower-layer signaling based cell switch.

In some embodiments, the second information comprises at least one of the following: information of a distributed unit associated with a candidate cell in a set of candidate cells; an indication of whether the set of procedures are performed during a cell switch from one candidate cell to another second candidate cell in a set of candidate cells; an indication of a cell switch from one candidate cell to another candidate cell in a set of candidate cells that does not require performance of the set of procedures; or an indication of a cell switch from one candidate cell to another candidate cell in a set of candidate cells that requires performance of the set of procedures.

In some embodiments, transmitting the information further comprises: transmitting a configuration for the lower-layer signaling based cell switch, the configuration comprising no information associated with a lower-layer signaling based cell switch.

In another solution, a method of communication comprises: transmitting, at a network device and to a terminal device, a lower-layer signaling indicating a cell switch to a target cell; and receiving, from the terminal device, an indication indicating completion of the cell switch, the indication comprising information of the target cell.

In some embodiments, receiving the indication comprises: receiving a further lower-layer signaling comprising the indication; or receiving a radio resource control signaling comprising the indication.

In some embodiments, receiving the further lower-layer signaling comprises: receiving the further lower-layer signaling at a distributed unit of the network device associated with the target cell; and transmitting, at the distributed unit and to a central unit of the network device, information indicating completion of the cell switch, the information comprising the information of the target cell.

In some embodiments, receiving the radio resource control signaling comprises: receiving the radio resource control signaling at a distributed unit of the network device; and forwarding, by the distributed unit, the radio resource control signaling to a central unit of the network device.

In some embodiments, the information of the target cell comprises at least one of the following: an identity of the target cell; or an identity of a configuration of a lower-layer signaling based cell switch associated with the target cell.

In another solution, a device of communication comprises: a processor configured to cause the device to perform any of the methods described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of terminal device, comprising:
receiving, from a network device, first information including L1/L2 Triggered Mobility (LTM) candidate configuration; and
determining, whether a set of procedures are performed based on the first information, the set of procedures comprising at least one of the following:
triggering a packet data convergence protocol (PDCP) entity of data radio bearers to perform data recovery;
discarding a packet data convergence protocol (PDCP) service data unit;
re-establishing a radio link control (RLC) entity; or
resetting a medium access control (MAC) entity.

2. The method of claim 1, wherein receiving the first information comprises:
receiving, from the network device, second information regarding whether to perform the set of procedures for the LTM.

3. The method of claim 2, wherein the second information comprises an indication indicating whether the set of procedures are performed, and wherein determining whether the set of procedures are performed comprises:
in accordance with a determination that the indication indicates that the set of procedures are not to be performed, determining that the set of procedures are not performed; or
in accordance with a determination that the indication indicates that the set of procedures are to be performed, determining that the set of procedures are performed.

4. The method of claim 2, wherein the second information comprises an indication indicating a mobility scenario of the LTM, and wherein determining whether the set of procedures are performed comprises:
in accordance with a determination that the mobility scenario of the LTM is an intra-central unit and intra-distributed unit scenario, determining that the set of procedures are not performed; or
in accordance with a determination that the mobility scenario of the LTM is an intra-central unit and inter-distributed unit scenario, determining that the set of procedures are performed.

5. The method of claim 2, further comprising:
transmitting, from a lower layer of the terminal device to upper layers of the terminal device, an indication indicating that the set of procedures are performed; and
performing the set of procedures by the upper layers.

6. The method of claim 1, wherein receiving the information comprises:
receiving, from the network device, a configuration for LTM, the configuration comprising third information assistant for the terminal device to decide whether to perform the set of procedures for the LTM.

7. The method of claim 6, wherein the third information comprises information of a distributed unit associated with a candidate cell in a set of candidate cells, and wherein determining whether the set of procedures are performed comprises:
in accordance with a determination that a target cell and a source cell are associated with different distributed units, determining that the set of procedures are performed; or
in accordance with a determination that a target cell and a source cell are associated with a same distributed unit, determining that the set of procedures are not performed.

8. The method of claim 6, wherein the third information comprises an indication of whether the set of procedures are performed during the LTM from one candidate cell to another second candidate cell in a set of candidate cells, and wherein determining whether the set of procedures are performed comprises:
in accordance with a determination that the set of procedures are performed during the LTM from a source cell to a target cell, determining that the set of procedures are performed; or
in accordance with a determination that the set of procedures are not performed during a cell switch from a source cell to a target cell, determining that the set of procedures are not performed.

9. The method of claim 6, wherein the third information comprises an indication of the LTM from one candidate cell to another candidate cell in a set of candidate cells that does not require performance of the set of procedures, and wherein determining whether the set of procedures are performed comprises:
in accordance with a determination that the third information comprises an indication of the LTM from a source cell to a target cell, determining that the set of procedures are not performed; or
in accordance with a determination that the third information does not comprise an indication of the LTM from a source cell to a target cell, determining that the set of procedures are performed.

10. The method of claim 6, wherein the third information comprises an indication of the LTM from one candidate cell to another candidate cell in a set of candidate cells that requires performance of the set of procedures, and wherein determining whether the set of procedures are performed comprises:
in accordance with a determination that the third information comprises an indication of & the LTM from a source cell to a target cell, determining that the set of procedures are performed; or in accordance with a determination that the third information does not comprise an indication of a the LTM from a source cell to a target cell, determining that the set of procedures are not performed.

11. The method of claim 6, wherein receiving the information further comprises: receiving, from the network device, a configuration for the LTM; and
wherein determining whether the set of procedures are performed comprises: in accordance with a determination that the configuration does not comprise the third information, determining that the set of procedures are performed.

12. The method of claim 1, further comprising:
transmitting, to the network device, an indication indicating completion of the LTM, and
wherein the indication comprising information of a target cell.

13. The method of claim 12, wherein transmitting the indication comprises:
transmitting a further LTM signaling comprising the indication; or transmitting a Radio Resource Control (RRC) signaling comprising the indication.

14. The method of claim 13, wherein transmitting the further LTM signaling comprises:
transmitting the further LTM signaling to a distributed unit of the network device associated with the target cell for transmission of the information of the target cell to a central unit of the network device.

15. The method of claim 13, wherein transmitting the radio resource control signaling comprises:
transmitting the radio resource control signaling to a central unit of the network device via a distributed unit of the network device associated with the target cell.

16. The method of claim 12, wherein the information of the target cell comprises at least one of the following:
an identity of the target cell; or
an identity of a configuration of the LTM associated with the target cell.

17. A terminal device of communication, comprising:
a memory configured to store instructions; and
a processor configured to execute the instructions to:
receive, from a network device, first information including L1/L2 Triggered Mobility (LTM) candidate configuration; and
determine, whether a set of procedures are performed based on the information, the set of procedures comprising at least one of the following:
triggering a packet data convergence protocol (PDCP) entity of data radio bearers to perform data recovery;
discarding a packet data convergence protocol (PDCP) service data unit;
re-establishing a radio link control (RLC) entity; or
resetting a medium access control (MAC) entity.

18. A method of a network device, comprising:
communicating with a terminal device, and
transmitting, to the terminal device, first information including L1/L2 Triggered Mobility (LTM) candidate configuration; and
wherein the terminal device determines whether a set of procedures are performed based on the information, the set of procedures comprising at least one of the following:
triggering a packet data convergence protocol (PDCP) entity of data radio bearers to perform data recovery;
discarding a packet data convergence protocol (PDCP) service data unit;
re-establishing a radio link control (RLC) entity; or
resetting a medium access control (MAC) entity.
